(19) United States
(12) Patent Application Publication
(10) Pub. No.: US 2013/0339262 A1
(43) Pub. Date: Dec. 19, 2013

(54) Method for Presenting Credentials to Prospective Employers or for Advanced Education

(71) Applicant: Hasan Almatrouk, Irvine, CA (US)

(72) Inventor: Hasan Almatrouk, Irvine, CA (US)

(21) Appl. No.: 13/525,829

(22) Filed: Jun. 18, 2012

(51) Int. Cl. G06Q 10/06

(52) U.S. Cl. 705/321

(57) ABSTRACT

The invention is a method for creating a resume comprising responding to prompts at a remote computer terminal, uploading/installing text, photographs, video feeds, and files. The completed resume can be edited and then electronically transmitted to a prospective employer or university. The employer's or college's representatives can then respond to the applicant electronically.

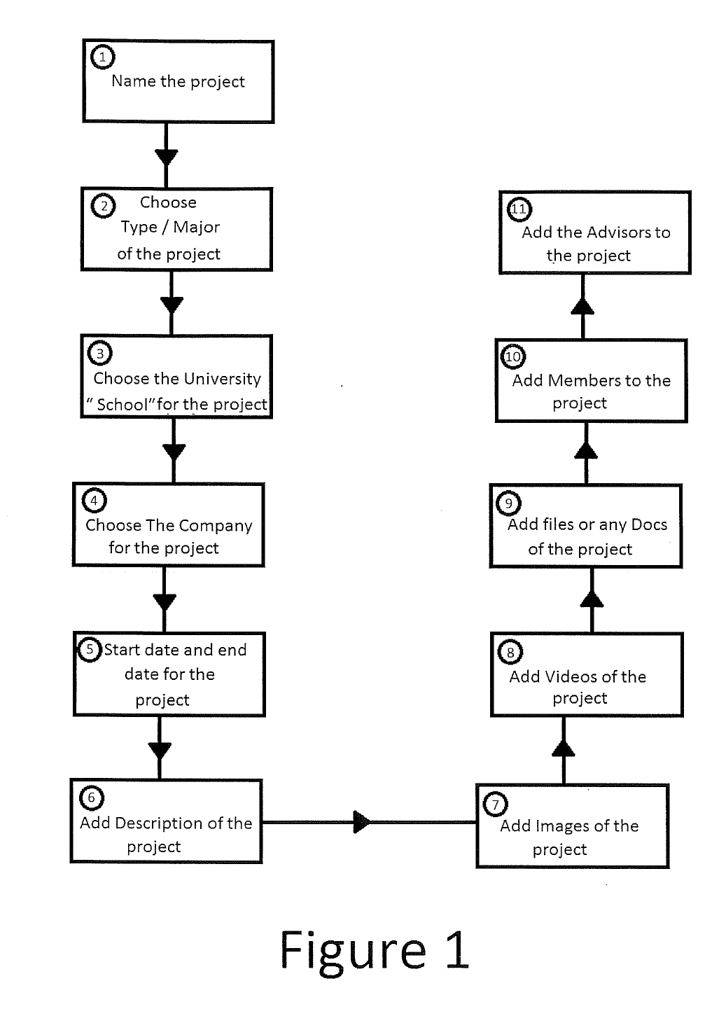

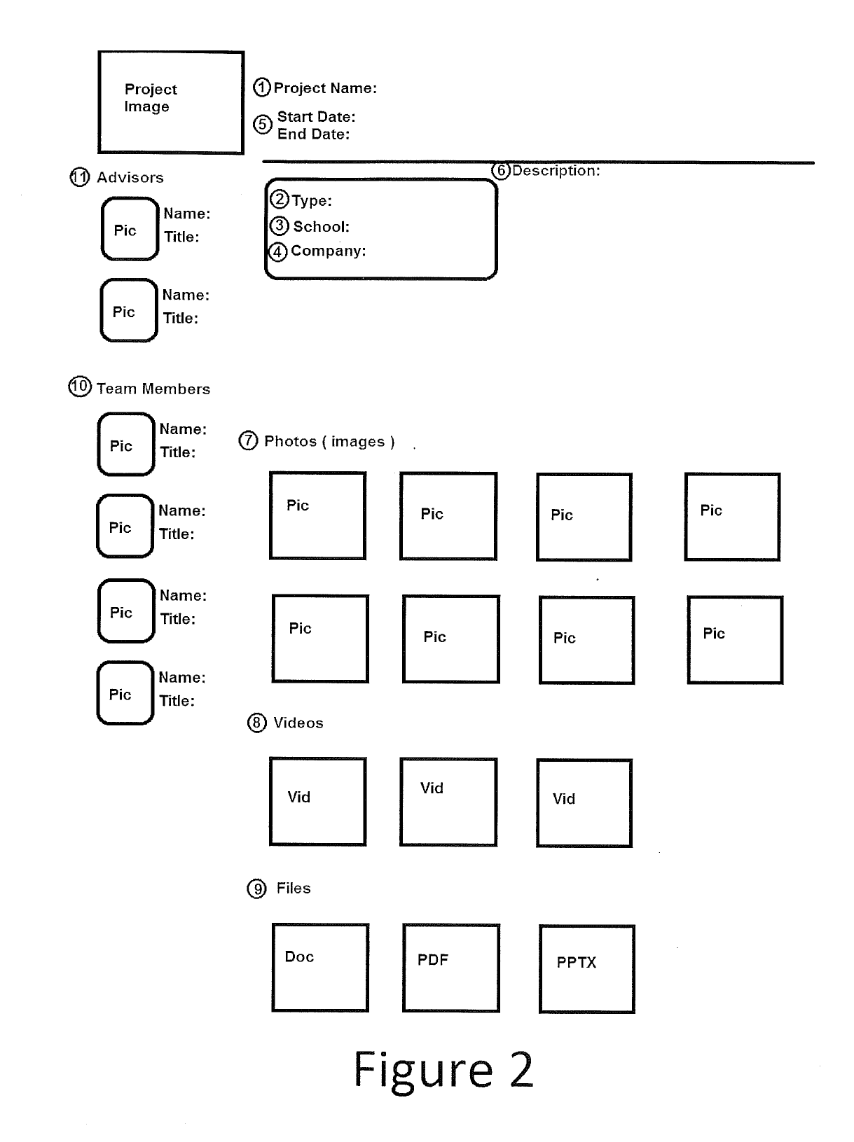

### CROSS-REFERENCE TO RELATED APPLICATIONS

None.

### FEDERALLY SPONSORED RESEARCH

Not applicable.

### BACKGROUND OF THE INVENTION

The social network created on the internet has broadened the opportunities for meeting other persons, sharing experiences and strengthening the bonds of friendship. College students and other job applicants have a need to obtain employment and to put their education and training to good use, or to seek specialization through advanced college degrees. This invention will allow the college student or applicant new to the job market, to get his or her “foot in the door,” by submitting high quality resumes which display credentials and achievements on a single computer page.

Typically employment applicants locate a prospective employer, perhaps over the internet via platforms such as “Craigslist,” “Monster.com,” or some other advertised posting, and then submit a resume. There may be several hundred applicants for a single position.

The paper resume cannot do justice to the applicant's actually abilities nor his or her aptitude for the particular job. Both the applicant and the employer suffer, because the applicant has not been able to demonstrate his or her true potential and the employer cannot adequately differentiate among the numerous candidates. Similarly, institutions offering advanced degrees rarely have the personnel and resources available to conduct in depth background investigation of applicants.

Others have taught how to create a network database for employment candidates, see for instance, Simon US Patent App. No. 2009/0049095; or have instructed on how to post credentials by text, photographs and video displays, see for instance, Ting US Patent App. No. 2008/0262859; or have provided advice on supplying live resume information, see for instance, Cox US Patent App. No. 2007/0265865; or have instructed on how to create a system for a college to collect data on applicants, see for instance, Lutz US Patent App. No. 2004/0143469; or, even how to use an avatar to creatively display the applicant's background, see Obafunawa US Patent App. No. 2008/0255861. But, NONE have incorporated a method for assembling detailed information on a single computer page that can be readily accessed over the internet by prospective employers or colleges offering advanced degree programs.

The Single Page Credential Builder solves this problem by allowing job applicants or higher education applicants to post text, photographs, video displays, and actual files on the projects that they worked on to an internet platform that can be accessed by prospective employers or universities. The invention is invaluable for those with engineering, architectural, biology, and chemistry training, as well as those with artistic abilities, because it allows them to create a visual display of their own work along with accompanying files. The project can be displayed with information regarding the advisor and the identities of those members who also worked on the project. Everything can be presented to the prospective employer or the university at one time, on a single screen shot.

### BRIEF SUMMARY OF THE INVENTION

The Single Page Credential Builder incorporates the comments of the student or employment applicant's resume on a single computer page. The employer or the university acquires a single screen shot to quickly assess the applicant's talents and determine whether a subsequent interview or telephone contact is worthwhile.

### BRIEF DESCRIPTION OF DRAWINGS

Attached as Drawing #1 is a step by step procedure for the applicant to enter data concerning his education and training projects.

Attached as Drawing #2 is a depiction of how the applicant's project(s) will be displayed to the prospective employer.

### DETAILED DESCRIPTION OF THE INVENTION

The need being addressed is the creation of a method for a student or job applicant to assemble his resume, with text, photographs, video, and files, and then place it on the internet. The student incorporates the information on a single screen shot. This is the ideal means for permitting access by the employer or college, because it presents readily verifiable credentials in a condensed format.

The student or job applicant locates the Single Page Resume Builder at his remote terminal. He or she follows the prompts to present the aspect(s) of education or job experience that best displays background and abilities. In the preferred embodiment, Drawing #1 contains the prompts to be examined by the applicant. Drawing #2 depicts the input to the screen shot based on the responses to the prompts.

At Drawing #2, the applicant enters his or her name, electronic return address and can provide a photograph for identification. The first substantive entry is to identify the project at Item #1. For instance, the project could be identified as “Urban Design,” “Graphic Design,” “Robotic Automobile Construction,” or by some other appellation. At Item #2, the applicant identifies his or her Major or Minor. At Item #3, the applicant inserts the name of the university or college. At Item #4, the applicant inserts the name of a private or public company or sponsor. At Item #5, the applicant inserts the start and end dates for the project. At Item #6, the applicant describes the project, such as to create a layout for city planning, to develop a trademark or logo, or to build a driverless car. At Item #7, the applicant uploads photographs. At Item #8, video can be uploaded. At Item #9, files or documents, in any format, such as PDF, PPT, 3D, or other format, can be inserted. At Item #10, the other participants in the project can be identified, so as to show the interaction of the members. And, at Item #11, the advisor's identity can be provided as a source for verifying that the work was properly completed.

The entire input is viewed on a single computer screen.

The student has now customized his or her Single Page Resume Builder. The applicant views the screen shot and can correct it. Then the applicant selects the employer's e-mail or website address and submits the resume. The applicant can repeat the process by sending out the resume to several different employers, or he or she can customize the resume to emphasize other projects that could be considered more relevant in another field of interest, for instance, the applicant could also have a Major in Electrical Engineering, and a Minor in Cinema or some other area. He or she may seek multiple career opportunities.

I claim:

1. A computer driven method comprising:
allowing for input of data related to job applicants' education and training experiences, including text, photographic, video and file materials on a single computer page at remote terminals,
permitting prospective employers or college screeners to receive the data at their own terminals,
allowing for confirmation of receipt of data and/or scheduling for further employment candidate interview.

2. The method as in claim 1, further comprising:
allowing for categorization or grouping and then recovery of inputted data by project.

3. The method as in claim 1, further comprising:
allowing for categorization or grouping and then recovery of inputted data by university.
